(19) United States
(12) Patent Application Publication
(10) Pub. No.: US 2006/0099422 A1
(43) Pub. Date: May 11, 2006

(54) Coating method and coated element

(75) Inventors: Joachim Gussone, Aachen (DE); Oliver Lemmer, Aachen (DE); Dirk Breidt, Wegberg (DE)

Correspondence Address: BANNER & WITCOFF, 1001 G STREET N W, SUITE 1100, WASHINGTON, DC, 20001, US

(73) Assignee: CemeCon AG, Wurselen (DE)

(21) Appl. No.: 10/529,258

(22) PCT Filed: Sep. 26, 2003
(86) PCT No.: PCT/EP03/10735

§ 371 Date: Aug. 18, 2005

(30) Foreign Application Priority Data
Sep. 27, 2002 (DE) 10245300.4

(51) Int. Cl. B44C 1/22; B32B 9/00

(52) U.S. Cl. 428/408; 216/37; 216/53; 427/248.1

(57) ABSTRACT

Disclosed are an element comprising a hard metal substrate (10) and a diamond layer (30), and a method for coating a hard metal substrate (10). Said hard metal substrate is provided with hard material particles (20) and surrounding binder material (22). The hard material particles (20) are surrounded by binding material (22) in a first area (24) comprising intact hard metal. The transition region of the first area (24) encompasses a deep profile having recesses (18) and elevations (16). The diamond layer (30) is braced with the substrate material (10) with the aid of said deep profile, portions of the diamond layer (30) being disposed deeper within the substrate (10) than elevations (16) of the first area (24). Said structure is obtained by means of a pretreatment process in which a hard metal substrate (10) is first subjected to selective etching in order to remove the binding material (22). A porous zone having a deep profile is formed. The hard material particles located within the porous zone (12) are removed by means of microbeams or a second, WC-selective etching step. A cobalt concentration on the surface is finally removed in a Co-selective etching step, and the substrate (10) is coated with a diamond layer by means of CVD.

The invention relates to a coated element and a method for coating an element.

According to the prior art, elements or portions of elements are provided with a surface coating to improve their mechanical characteristics. According to the prior art functional surfaces particularly for tools are provided with a diamond layer. A known prior art method is to apply a diamond layer by means of a CVD (chemical vapour deposition) process. One such method for coating is disclosed e.g. in WO 98/35071.

Coated elements comprise a substrate material and a diamond layer applied to said substrate material. Hard metals and comets are considered as substrate materials in the context of the present invention, i.e. sinter materials made of hard material particles and binding material particularly having WC grains in a matrix containing Co. Diamond-coated hard metal- and/or cermet tools are used amongst other things in metal machining. In metal machining particularly the extreme hardness of the diamond positively affects the protection of the tool against wear.

In order to obtain a good adherence of the diamond coating on the substrate there are various prior art pre-treatment methods.

U.S. Pat. No. 6,096,377 discloses a method for coating a hard metal substrate with a diamond layer. The method comprises pre-treating the substrate with a WC-selective etching step and with a Co-selective etching step. Nucleation with diamond powder and a subsequent diamond coating are proposed for the applying of a diamond layer. In this case allegedly the Co-selective etching step, the WC-selective etching step and the nucleation step can be executed in any order.

In DE 195 22 371 it is proposed for the applying of a diamond layer to a hard metal substrate a first Co-selective etching step with subsequent cleaning of the etched substrate surface and then a WC-selective etching step with subsequent cleaning. To the hard metal substrate pr treated in this manner is applied a diamond layer by means of a CVD process.

With regard to the two cited printed publications it can be concluded that two-step pre-treatment methods comprising a first Co-selective etching step and then a WC-selective etching step in many cases do not provide for a sufficient layer adhesion. For if in the second WC-selective etching step there is executed a complete etching of the WC grains lying on the surface, the surface will then comprise a Co-concentration which inhibits a good layer adherence. If however only partial WC etching is executed the WC grains are etched on the surface at the boundaries of the grains, i.e. in the subsequent transition region between substrate and diamond layer. Then however there is no intact WC structure which leads to red layer adhesion and mechanical strength.

WO 97/07264 discloses a pre-treatment method for the CVD diamond coating of a hard metal. In this case in a first step an electrochemical etching of the hard metal is executed wherein in an electrolyte (e.g. 10% NaOH) the substrate is connected as an anode and is electrochemically etched. In a second step the Co binding material is selectively etched. Finally a diamond layer is applied in a CVD process.

The results obtained by means of this or comparable two-step pre-treatment methods comprising a first WC etching step and then Co-etching step provide an acceptable layer adhesion for some applications. In the case of severe stresses and particularly shearing stresses and dynamic compression stresses however insufficient strength is obtained by means of said pre-treatment.

The object of the invention is to propose a coated element and a coating method for said coated element wherein the element is provided with an increased loading capacity in the case of differing mechanical stresses.

Said object is achieved by means of an element according to Claim 1 and the method according to the Claims 9 and 14. Dependent claims relate to preferred embodiments of the invention.

In accordance with the invention a particular quality of the transition region between the substrate material (hard metal or cermet) and the diamond layer is proposed. In order to describe the structure, the coated element should be observed in the vertical section with respect to the diamond layer wherein for the purposes of the description it is assumed that the substrate is disposed below and the diamond layer above. This nevertheless serves only for the ease of visualisation and should not be considered as binding with respect to the geometry of the element and the arrangement of the diamond coating on said element.

In the case of the element according to the invention there is provided a first region of intact substrate material. Intact substrate material refers to that fact that hard material particles are embedded in and/or surrounded by binding material and that the phase boundaries of the hard material particles are intact.

The diamond layer is disposed above the first region. In this case the transition region of the first region, i.e. the upper boundary area of the first region, comprises a depth profile, i.e. a roughness having indents and elevations. These indents and elevations are visible for example in the cross section. By growing the diamond layer in the indents said diamond layer is braced with the substrate. By this is meant that there are portions of the diamond layer observed in the section which portions of the diamond layer are disposed deeper in the substrate than elevations of the first substrate region with intact substrate material, i.e. hard material particles and binding material.

By means of this bracing there is obtained a good adhesion of the diamond layer. The serration and/or bracing provides for the good absorption of compression and shear stresses. By means of the depth profile in the transition region compression stresses are distributed over a large area. The elevations offer resistance with respect to shearing forces.

In the case of the element according to the invention it is preferable that the transition region, i.e. the substrate surface, comprises no grinding flaws and also that in the transition region there are no shatter hard material particles such as are produced for example by grinding. In addition the surface should be free of grinding-related porosity and grinding-related concentrations of binding material.

For the layer adhesion it is preferable that in the transition region there are exclusively completely binding material-free surfaces which are disposed towards the diamond layer. On no account should there be a concentration of binding material.

In accordance with a further embodiment of the invention there is disposed a porous zone between the first region and the diamond layer in which the hard material particles ae free of binding material. The hard material particle structure is preferably intact in the porous zone and not weakened by etching at the grain boundaries. The porous zone is followed by the diamond layer above. A better layer adhesion is obtained due to the removing of the binding material in the porous zone.

In this case it should be noted that an over-thick porous zone could in turn weaken the layer adhesion and/or the strength of the transition region. For this reason a shallow porous zone is preferable. Particularly preferable is a thickness between 3-7 μm. In accordance with a further embodiment of the invention the average thickness d of the porous zone is less than or equal to the maximum peak-to-valley height Rmax and preferably also the average peak-to-valley height Rz of the transition region. This leads to a good bracing, good adhesion and high mechanical stability. In this case the maximum peak-to-valley height Rmax and the average peak-to-valley height Rz in cross section are to be considered as the average and/or maximum value of the distance between ‘peaks’ and ‘valleys’.

In the case of the first variant of a method in accordance with the invention recounted in Claim 9 with respect to a substrate material comprising hard material particles and surrounding binding material there is executed in a first step a binding material-selective etching and in a second step a hard material-selective etching and in a third step a binding material-selective etching. The substrate pre-treated in this manner is then coated with a diamond layer.

In this case the binding material is preferably removed in the first step in an edge region of the substrate. Said edge region preferably comprises a depth profile. In the second step hard material particles in the edge zone are removed such that from the etching depth profile of the first step there is obtained a surface profile with elevations and indents. The hard material particles exposed in the first etching step are preferably completely removed.

By way of the etching of the hard material particles there is obtained a binding material concentration of the surface which is removed in the third step. In this case is it preferable that the etching executed in the third step comprises a lesser etching depth than the etching executed in the first step. This provides only for the forming of a small porous zone on the profiled she. On such a structure there is obtained a good adhesion of the diamond layer applied to said structure. The method is particularly preferred for hard metals comprising WC hard material particles and binding material containing Co.

In the case of the second variant of a method in accordance with the invention recounted in Claim 14 as in the case of the first variant there is also executed a selective etching of the binding material. By this means there is preferably produced a porous edge zone having a depth profile in which the binding material is removed. In a subsequent mechanical removal step the thus pre-treated substrate surface is subjected to a blasting process comprising blasting particles. Said blasting particles are preferably SiC particles comprising a grain size of less than 100 μm and better less than 70 μm and particularly preferably less than 30 μm. By this means hard material particles on the surface are removed, preferably in the porous edge zone formed in the first step. After the mechanical removal step there is obtained a surface comprising a depth profile having elevations and indents. Said surface can be directly used preferably after cleaning for the applying of a diamond layer since, thanks to the blasting process, there are brought about on the surface no concentrations of binding material which reduce adhesion. In this manner a shallow porous zone also remains after the blasting. In accordance with a further embodiment of the invention there can be provided an increased depth of the porous zone by means of a binding material-selective etching step in order to improve the adhesion.

The substrate materials observed in accordance with the invention are hard metals or cermet comprising sintered hard material particles and binding material. Co, Ni, Fe for example can be used as binding materials and WC, TiC, TaC, NbC for example as bard materials. The preferred substrate material used for the element according to the invention and the method in accordance with the invention is a hard metal having sintered WC-hard material particles and binding material containing Co. Particularly preferably are materials with Co—Ni—Fe binders. In this case preferably the Co portion is 0.1-20% and preferably 3-12% and better 6-12% and particularly preferably 10-12%. Particular benefits are obtained with substrate materials with Co portions over 6% which are robust against impact stress. In addition in the case of fine-grained hard metals it is preferred that said fine-grained hard metals also comprise chrome and vanadium.

As substrate materials in principle also coarse grained (grain size 2.5-6 μm), average grain types (gin size 1.3-2.5 μm) and fine-grained types (0.8-1.3 μm) of hard metals can be used. Preferred however are superfine-grained types (0.5-0.8 μm grain size) and ultrafine-grained types (grain size 0.2-0.5 μm). Superfine and ultrafine types are distinguished by increased hardness and bending strength.

The deep profile of the first area comprises in accordance with a further embodiment an average peak-to-valley height Ra of 1-20 μm and preferably 2-10 μm. Particularly preferable is an average peak-to-valley height Rz of 3-7 μm. In accordance with a further embodiment of the invention the average peak-to-valley height Rz of the deep profile is greater than the grain size of the hard metal substrate. Particularly in the case of super-fine and ultrafine-grained types preferably the Rz is even more than five times and more preferably more than ten times the grain size.

In the case of the method in accordance with the invention according to a further embodiment in the first etching step an average etching depth of 1 to 20 μm is obtained. Preferred is an etching depth of 2 to 10 μm and particularly preferred 3 to 7 μm. In the case of the first step the acid penetrates at varying velocities into the surface-adjacent region of the substrate such that a porous edge zone is obtained which porous edge comprises a deep profile. By means of the etching the peak-to-valley height of the transition region is predetermined. In this case the maximum penetration depth of the acid determines the peak-to-valley height value Rmax and the etching depth variance determines the Rz and the Ra value. The penetration depth (and particularly the value Rmax) can be influenced by appropriate choice of the acid and adjustment of the etching time. The values Ra and Rz are preferably also influenced by the choice of the acid, and particularly of its dilution rate. In the case of electrochemical methods the parameters can be adjusted also by the choice of the electrical parameters.

In principle any acid that etches the binding material and particularly cobalt can be used for the etching executed in the first step. Particularly preferable are electrochemical etching methods comprising direct or alternating current with HCl or H₂SO₄. Also preferred are is electrochemical etching methods with dilute HCl, H₂SO₄ solutions. In addition, HE and pr ty mixtures of H₂SO₄/H₂O₂, HCl/H₂O₂ and HCl/HNO₃ can be used for the etching.

Hard material particles and particularly tungsten carbide ins are etched in the second etching step executed in the first variant of the method according to the invention. Chemicals that selectively etch WC can be used for this purpose. The corresponding treatment is possible with potassium ferricyanide/alkali compounds, preferably potassium manganate/alkali compounds. Particularly preferable are electrochemical methods with alkali mixtures, for example made of caustic sodas caustic potash solution and/or sodium carbonate.

In the case of the first variant and optionally also in the case of the second variant of the method in accordance with the invention a third, Co-selective etching step is executed. The third etching step is preferably executed as electrochemical etching with sulphuric acid or hydrochloric acid. There is hereby produced a porous zone on the surface of the substrate already profiled by means of the first two steps in which porous zone the binding material is removed. Said porous zone is preferably of a lesser thickness.

The coating is preferably executed by means of a CVD process. In said method the diamond grows on the produced surface. Due to the depth profile of the pre-treated substrate there is obtained an excellent bracing between diamond layer and substrate.

In this case the peak-to-valley height produced by means of pre-treatment method is not dependant in principle on the substrate grain size. The peak-to-valley height is produced by the depth profile obtained in the first step. A excellent bracing between diamond layer and substrate is also achievable in this manner in the case of super-fine- and ultrafine-grained types.

There follows a more detailed account of embodiments based on drawings. In the drawings;

FIG. 1 shows a cross section through a hard metal substrate having a porous zone;

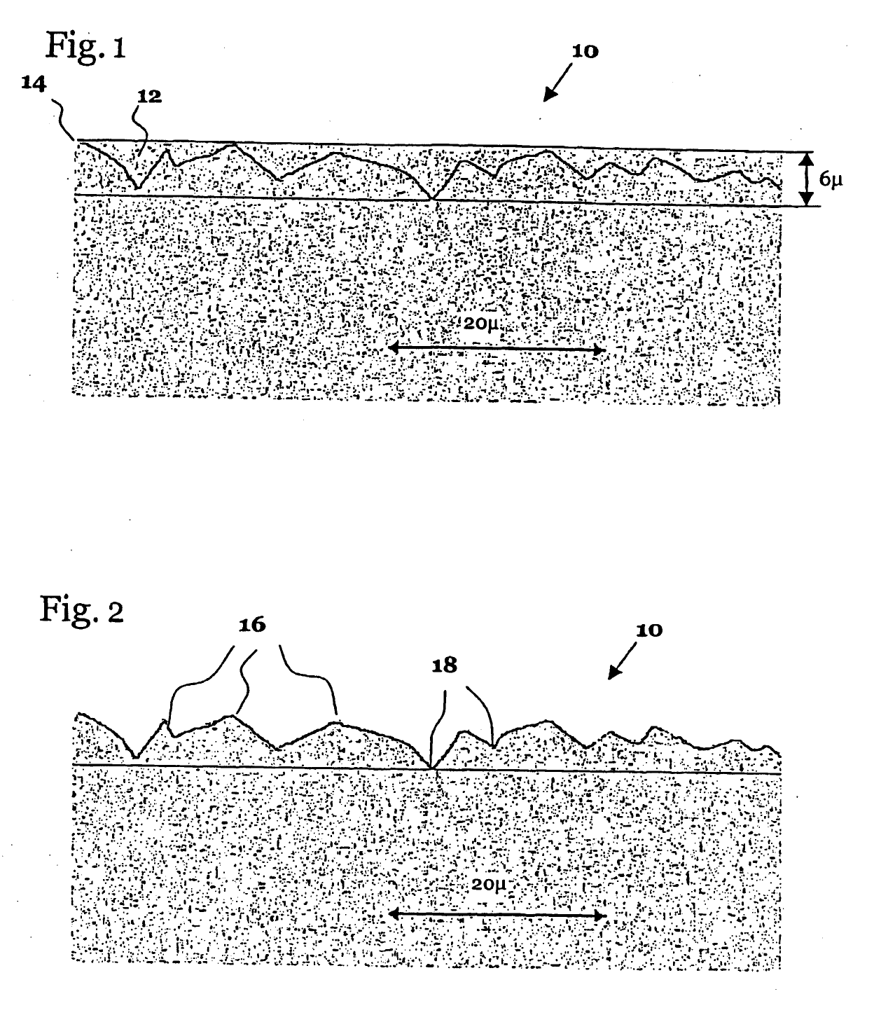

FIG. 2 shows a cross section through a hard metal substrate having a profiled surface;

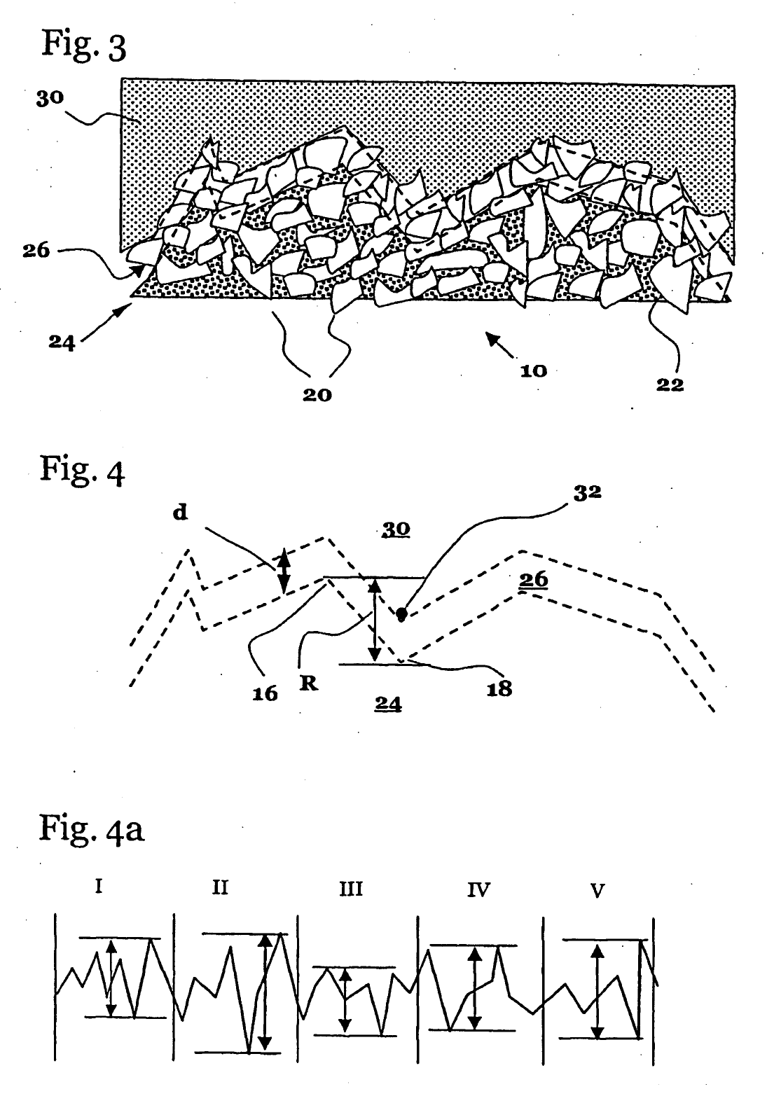

FIG. 3 shows a symbolic illustration of a cross section through an element having a substrate and a diamond layer;

FIG. 4 shows a symbolic illustration of the deep profile from FIG. 3;

FIG. 4a shows a schematic diagram for the purpose of determining peak-to-valley height curves;

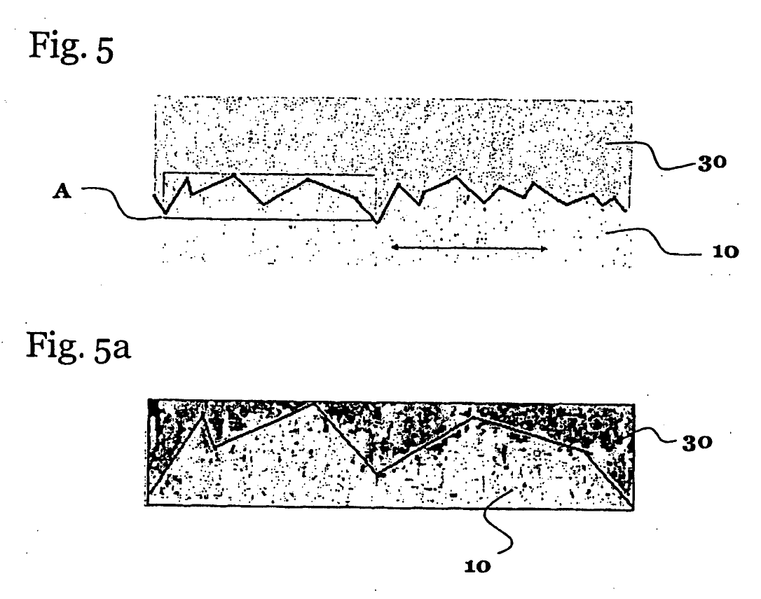

FIG. 5 shows a cross section through a diamond-coated element;

FIG. 5a shows an enlargement of the region A from FIG. 5;

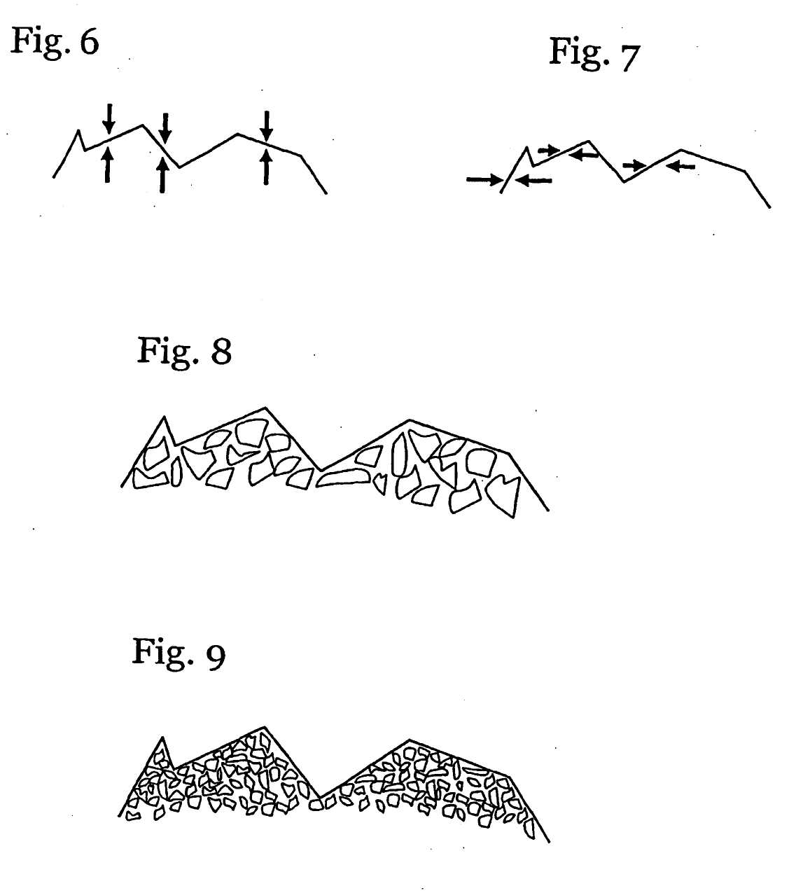

FIG. 6 shows a symbolic illustration of the attack of compression stresses on the profile of a transition region;

FIG. 7 shows a symbolic illustration of the attack of shear stresses on the deep profile of a transition region;

FIG. 8 shows a symbolic illustration of the profile of a transition region in the case of a coarse-grain hard metal;

FIG. 9 shows a symbolic illustration of the profile of a transition region in the case of a fine-grain hard metal.

A tool made of a hard metal is to be coated with a diamond layer. The tool material (substrate) 10 is a superfine-grained type having WC particles in the order of magnitude of 0.5 to 0.8 μm and a Co binder having 10% Co.

The substrate 10 is pre-treated before the application of the diamond layer. In this case the substrate 10 is subjected to a first etching step by which means a porous zone 12 is produced on the surface and wherein the binding material has been completely removed. The porous zone 12 comprises a depth profile which is provided by the boundary line 14 illustrated in FIG. 1. In this case the acid used on the substrate 10 has penetrated the surface to different depths in different places. The porous zone 12 comprises a maximum etching depth of 6 μm.

In a second step the WC grains in the porous zone 12 are completely removed. In this case the substrate is etched with KMNO₄/NaOH (100 g/l, 100 g/l). By this means is removed the tungsten carbide in the porous zone 12. There is obtained a surface structure as shown in the section view of FIG. 2. The surface of the substrate 10 is rough and comprises a number of elevations 16 and indents 18. The resulting surface profile corresponds to the profile of the porous zone from FIG. 1 and thereby to the etching depth profile of the first etching step.

The removal of the tungsten carbide leaves a concentration of cobalt on the surface after execution of the second etching step which cobalt concentration is referred to here as the cobalt sponge. The cobalt sponge is electrochemically removed in a third step with concentrated sulphuric acid. The third etching step with concentrated sulphuric acid is executed in such a manner that above all the cobalt sponge is removed and a porous zone (i.e. a surface region in which surface region the binder material has been removed) of only a shallow depth is obtained. In the example the etching depth can be adjusted by the dilution of the sulphuric acid. The treatment duration is of little significance for the etching depth since a passivation layer forms as soon as cobalt has been completely removed from the surface.

This is shown in a symbolic illustration in FIG. 3. The substrate 10 comprises WC hard material particles 20 and binding material 22. The WC grains form a WC structure. In a lower first region 24 the hard metal substrate is intact, i.e. WC-grains are surrounded by binding material. The first region 24 is followed by a porous zone 26 above. WC grains 20 are not surrounded by binding material in the porous zone 26.

It should be mentioned that the symbolic illustration in FIG. 3 serves only for ease of visualisation and is not to scale.

The porous zone 26 is finally followed by a diamond layer 30. The diamond layer 30 is applied after completion of the pre-treatment on the pre-treated substrate surface. This is carded out by means of a prior art CVD process as disclosed for example in WO 98/35071 wherein CH₄ is added in a hydrogen atmosphere and is activated on wire-shaped heating elements such that at a substrate temperature of approx. 850° C. a diamond layer forms on the substrate.

As shown in FIG. 3 the binding material 22 has been removed in the porous zone 26 and therefore does not prevent the adhesion of the diamond layer 30 to the substrate 10.

FIG. 4 shows in a further symbolic illustration the transition region between substrate 10 and diamond layer 30. In this case the edge lines of the corresponding areas in FIG. 3 of the first area 24, the porous zone 26 and the diamond layer 30 are shown as dashed lines. These illustrations are preferably used to explain the characteristics of the transition region.

The porous zone 26 comprises an average thickness indicated here as d. The surface of the first area 24 comprises a surface profile having elevations 16 and indents 18. The distance measured in a vertical direction between an elevation 16 and an indent 18 is indicated here as R.

The peak-to-valley curves Ra, Rmax, Rz are defined for surfaces and are usually measured by scanning methods. For the presently observed coated elements the values are determined with respect to the cross section. Values are determined according to DIN EN ISO 4287, by not considering long wave portions due to the external shape of the element. Of the remaining profile the five part-sections are observed as shown in FIG. 4 a. For each part section the individual peak-to-valley height is determined as the sum of the height of the optimum profile pas and the depth of the largest indent within the part section. From this the average peak-to-valley height Rz is determined as the arithmetical average value of the individual peak-to-valley height and the maximum peak-to-valley height Rmax as the greatest individual peak-to-valley height of the measured section.

For the transition region it is preferred that the average thickness d of the porous zone 26 is equal to or less than the maximum distance between elevations and indents, i.e. the Rmax-value. By this means there is obtained as shown in FIG. 3 a good bracing of the diamond layer 30 with the substrate 10. In this case portions of the diamond layer 30 (as in the example of FIG. 4 for example a lower peak 32) are disposed deeper than elevations of the first area (in FIG. 4 for example the elevation 16). It is further preferable that d be less than or equal to the average peak-to-valley height Rz.

FIG. 5 shows the substrate 10 from FIG. 2 comprising a diamond layer applied to said substrate 10. It is clear that the transition region comprises a depth profile with elevations and indents. FIG. 5a shows an enlargement of the region A from FIG. 5. Here is clearly discernible the bracing of the diamond layer 30 with the substrate 10.

In the case of the pre-treatment process described above the morphology of the transition region is irrespective of the grain size of the hard metal used. The peak-to-valley height of the transition region is determined by the first etching step. Thus the same surface morphology can bc obtained for hard metals with different grain sizes. This is symbolically illustrated in FIG. 8 and FIG. 9 wherein the same deep profile is achieved in the case of different grain sizes.

By means of the bracing of the diamond layer 30 with the substrate 10 described above there is obtained a particularly good layer adhesion. The layer adhesion is also particularly robust with respect to dynamic compression stresses and shearing stresses. As shown in the symbolic illustration of FIG. 6 compression stresses are distributed over a larger area due to the surface peak-to-valley height and can therefore be better transferred from the diamond layer 30 to the substrate 10. In the case of shearing stresses we bracing comprising the is elevations and indents of the diamond layer offer a good hold on the substrate 10.

While the exemplified embodiment described above provides as a pre-treatment method for a three-step etching method; in an alternative method the second and potentially even the third etching step are replaced by a mechanical removal step.

After executing the first etching step and producing a porous zone 12 comprising a depth profile (see also FIG. 1) the substrate to be coated is micro-blasted with SiC-particles. Thereby WC particles are removed in the porous zone 12. A rough surface with very little porosity is obtained. The surface produced generally comprises no Co concentration such that it is possible to execute the coating without a further Co-selective etching step. Nevertheless a prior cleaning of the substrate generally makes sense e.g. in an ultrasound bat.

In the alternative method a further binding material-selective etching step can also be executed after blasting in order to enlarge the porous zone on the surface.

The pre-treatment and subsequent coating of an element for a tool is preferably executed only in the functional region, i.e. for example in the case of a cutting tool in the region of the blade.

There follow descriptions of further detailed application examples.

### 1ST EXAMPLE

A milling tool (diameter 10 mm) mad of coarse-grain hard metal (grain size 3 μm) having a cobalt portion of 6% is to be coated.

In the first step the functional region of the tool (30 mm immersion depth) is electrochemically etched in dilute HCl (3%) 2 min. at a current strength of 0.1 A. There is obtained a porous zone having a maximum etching depth of 6 um.

In the second etching step the functional region of the tool is etched with KMNO₄/NaOH (100 g/l/100 g/l, 30 min, 50° C.). By means of etching the tungsten carbide in the porous zone is completely removed until a cobalt concentration is finally left on the surface.

This cobalt sponge is electrochemically removed in the third step with concentrated sulphuric acid (98%, 3 A, 3 min.). Due to the concentrated sulphuric acid only the cobalt concentration is removed; there is obtained only a very shallow porous zone.

After a cleaning step the substrate pre-treated in this manner is coated in a CVD process with a 10 μm thick diamond layer.

### 2ND EXAMPLE

A tool (milling tool, diameter 10 mm) made of ultrafine-grained hard metal (grain size 0.4 μm) laving a cobalt portion of 10% is to be coated.

The tool is etched in the first step in HNO₃ (25%, 3 mini). There is obtained a porous zone having a maximum etching depth of 10 um.

In the second step only the functional region is etched. In this etching step the tungsten carbide of the porous zone is removed with KMNO₄/NaOH (100 g/l/100 g/l, 30 min., 50° C.). The porous zone is removed by etching the tungsten carbide.

The cobalt sponge formed on the surface is removed in the third step. The cobalt concentration is electrochemically removed by means of hydrochloric acid (3%, 0.1 A, 5 min.) and there is obtained a porous zone of approx. 6 μM.

The substrate is coated in the CVD process with a diamond layer thickness of 6 μn.

### 3RD EXAMPLE

A tool made of hard metal (grain size 1 μm) having a cobalt portion of 10% is etched in the first step with HNO₃ (25%, 3 min.). There is obtained a porous zone having a maximum etching depth of 6 um.

The functional region of the tool is thereafter micro-blasted with SiC until the exposed WC grains of the porous zone are removed. There is obtained a rough WC surface with very little porosity which surface is coated after an intensive cleaning step with ultrasound treatment in an ethanol bath with a diamond layer of 8 μm thickness.

1. Element having
a substrate of a hard metal or cermet comprising hard material particles and binding material
and a diamond layer,
wherein the diamond layer is disposed over a first region of intact substrate material within which hard material particles are surrounded by binding material
wherein the transition region of the first region, which is disposed towards the diamond layer, comprises a depth profile having indents and elevations,
and wherein the diamond layer is braced with the substrate material such that portions of the diamond layer are disposed deeper in the substrate than elevations of the first region
characterised in that:
between the first region and the diamond layer there is disposed a porous zone in which hard material particles are free of binding material and
wherein the hard material particles form an intact hard material particle structure within the porous zone and are not weakened at the grain edges by etching.

2. Element according to claim 1 wherein the porous zone comprises an average thickness of 3-7 μm.

3. Element according to claim 1 wherein the porous zone comprises an average thickness d, the depth profile of the transition region of the first region comprises an average peak-to-valley height Rz and a maximum peak-to-valley height Rmax and wherein d is less than or equal to Rmax and preferably d is less than or equal to Rz.

4. Element according to claim 1 wherein the substrate material contains WC hard material particles and a binder containing Co, and wherein the grain size of the hard material particles is less than 0.8 μm and preferably less than 0.5 μm.

5. Element according to claim 1 wherein the binding material contains 3 to 12% and preferably more than 6% and particularly preferably 8 to 10% cobalt.

6. Element according to claim 1 wherein the transition region of the first region comprises an average peak-to-valley height Rz of 1 to 20 μm, preferably 2 to 10 μm and particularly preferably 3 to 7 μm.

7. Element according to claim 1 wherein the average peak-to-valley height Rz of the transition region of the first region is greater than the grain size of the hard metal, preferably more than five times the grain size of the hard metal.

8. Method for coating a substrate material with a diamond layer wherein the substrate material contains hard material particles and binding material wherein
a binding material-selective etching is executed in a first step, wherein the binding material in a border zone of the substrate is removed,
a hard material-selective etching is executed in a second step, wherein the hard material particles in the border zone are completely removed so that a surface profile with elevations and indents is created,
a binding material-selective etching is executed in a third step, wherein a binding material concentration on the surface is removed,
and the substrate is coated with a diamond layer thereafter.

9. Method according to claim 8 wherein the etching executed in the third step comprises a lesser etching depth than the etching executed in the first step.

10. Method according to claim 8 wherein in the second step the etching is executed with one of the following chemicals: compounds of potassium permanganate and caustic soda, compounds of potassium ferricyanide and caustic soda, caustic soda, caustic potash solution and/or sodium carbonate.

11. Method according to claim 8 wherein in the third step the etching is executed as electrochemical etching with sulphuric acid and/or hydrochloric acid or as chemical etching with HCl/H₂O₂ or H₂SO₄/H₂O₂.

12. Method for coating a substrate material with a diamond layer (wherein the substrate material comprises hard material particles and surrounding binding material wherein
in a first step a selective etching of the binding material is executed,
hard material particles are removed in a subsequent mechanical removal step by means of a blasting process with blasting particles,
and the substrate is afterwards coated with a diamond layer.

13. Method according to claim 12 wherein a binding material-selective etching step is executed after the mechanical removal step.

14. Method according to claim 12 wherein a cleaning step is executed before the coating.

15. Method according to claim 12 wherein the blasting particles consist of SiC and comprise a grain size of less than 100 μm.

16. Method according to claim 8 wherein in the first step an average etching depth of 1 to 20 μm, preferably 2 to 10 μm and particularly preferably 3 to 7 μm is achieved.

17. Method according to claim 8 wherein in the first step the etching is executed with one of the following chemicals: HCL, HNO₃, compounds of H₂SO₄ and H₂O₂, compounds of HCl and H₂O₂.

18. Method according to claim 8 wherein the diamond layer is applied by means of CVD.

19. Method according to claim 12 wherein in the first step an average etching depth of 1 to 20 μm, preferably 2 to 10 μm and particularly preferably 3 to 7 μm is achieved.

20. Method according to claim 12 wherein in the first step the etching is executed with one of the following chemicals: HCL, HNO₃, compounds of H₂SO₄ and H₂O₂, compounds of HCl and H₂O₂.

21. Method according to claim 12 wherein the diamond layer is applied by means of CVD.
